(19) United States
(12) Patent Application Publication
(10) Pub. No.: US 2008/0295988 A1
(43) Pub. Date: Dec. 4, 2008

(54) METHOD FOR REMOVAL OF CORES FROM NIOBIUM-BASED PART, AND RELATED CASTING PROCESS

(75) Inventors: Stephen Francis Bancheri, Albany, NY (US); Frederic Joseph Klug, Schenectady, NY (US); Robert Joseph Lyons, Burnt Hills, NY (US); Joan Katherine McKiever, Pattersonville, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/167,774

(22) Filed: Jul. 3, 2008

Related U.S. Application Data
(63) Continuation-in-part of application No. 11/276,002, filed on Feb. 9, 2006.

(51) Int. Cl. C01F 17/00

(52) U.S. Cl. 164/47; 423/21.1

(57) ABSTRACT

A method of removing an yttria-based core from a niobium-based part is described. In the method, the core is treated with an effective amount of a leaching composition. The leaching composition is based on nitric acid, or a combination of nitric acid and phosphoric acid. The core material is effectively removed from the niobium-based part, and the process of removing the core does not detrimentally affect the quality of the part. Related casting techniques for various niobium-based parts are also described.

The present application is a Continuation-In-Part of application Ser. No. 11/276,002, filed on Feb. 9, 2006; and claims the benefit of that application.

### BACKGROUND OF THE INVENTION

The present invention relates generally to turbine parts, and more particularly, to a cast part which contains internal passages or other cavities.

Due to the harsh environment associated with operation of a turbine engine, the parts thereof must consist of materials which can withstand the fluid speeds, temperatures, and stresses created during operation of a turbine engine. The turbine parts, especially the blades, must be constructed to satisfy minimums associated with oxidation resistance, intermediate-temperature pulverization resistance, fracture toughness, fatigue resistance, and impact resistance.

Understandably, these are but a few of many design considerations which are addressed to determine the operability of a part formed of a selected material. Additionally, due to the exacting nature associated with the assembly of the turbine engine, casting performance, manufacturability, and “machinability” are also important considerations to the selection of a part material.

It is well understood that the operating temperature of a turbine is one aspect of its operating efficiency. Nickel-based superalloys have often been the materials of choice for the “hot” sections of the turbine, where temperatures as high as about 1150° C. are encountered. However, advanced turbine engine designs require parts formed of materials which can withstand ever-increasing operating temperatures to attain improvements in engine performance.

These considerations prompted the investigation of a new generation of materials, known as refractory metal intermetallic composites (RMIC's). Many of these alloy materials are based on niobium (Nb) and silicon (Si), and are described, for example, in U.S. Pat. No. 5,932,033 (Jackson and Bewlay); U.S. Pat. No. 5,942,055 (Jackson and Bewlay); U.S. Pat. No. 6,419,765 (Jackson, Bewlay, and Zhao); and U.S. Pat. No. 7,296,616 (Bewlay et al), all of which are herein incorporated by reference. As an example, the niobium silicide (NbSi) materials, which have a multi-phase microstructure, combine a high-strength, low-toughness silicide phase with at least one lower-strength, higher-toughness Nb-based metallic phase. They often have melting temperatures of up to about 1700° C., and possess a relatively low density as compared to many nickel alloys. These characteristics make such materials very promising for potential use in applications in which the temperatures exceed the current service limit of the nickel-based superalloys. The niobium silicide materials often include at least about 1-25 atom % silicon, while also comprising one or more of the following elements: titanium, hafnium, chromium, and aluminum.

In addition to the high temperatures and pressures associated with the operation of a turbine, the turbine generally includes a plurality of parts with relatively complex geometries. For example, a turbine often includes several cast blades, fins, and/or vanes, which have airfoil-shaped cross-sections. Due to the temperature associated with operation of the turbine, these parts often include cooling passages which are integrally formed within the part, usually through casting. One of the most popular casting techniques is investment casting, sometimes referred to as the “lost wax process”.

Casting a part with integral cooling passages requires providing a mold and a core, such that the passages are formed during casting of the part. The core is usually formed from ceramic-based materials such as alumina, zircon, or silica. Once the part is removed from the mold, the core material must be removed from the cooling passages. Several important considerations must be addressed in removing the core material from the cast part.

When the cast parts are formed from nickel-based or other superalloy materials, the core material is often removed by immersing the part in a caustic bath. Treatment of the superalloy parts in such a bath very effectively dissolves the core material, and allows it to be drained or otherwise removed from the internal sections of the part. Caustic solutions like potassium hydroxide and sodium hydroxide have proven to be particularly effective at dissolving the material of the ceramic-based cores. Furthermore, the caustic materials do not detrimentally affect the superalloy part being cast. This attribute is very important for producing parts which must meet high standards of physical integrity and dimensional tolerances. (In marked contrast, acids—especially strong acids like hydrochloric acid—attack superalloy materials, and are therefore not typically used for this purpose).

Unfortunately, use of the caustic materials to accomplish the same task in the case of RMIC materials like niobium silicides has proven to be problematic. While the caustic compounds are capable of dissolving the yttria-based core materials used as cores for the niobium silicide materials, they can also destructively attack the niobium silicide part itself. The detrimental effect on the part is unacceptable in the case of high performance castings like those needed for turbine engine systems.

In view of the needs and concerns discussed above, new leaching processes for removing cores from cast RMIC parts would be welcome in the art. The processes should be capable of effectively removing cores—especially yttria-based cores—from the internal sections of the castings. Moreover, use of the leaching processes should not adversely affect the cast part, i.e., in terms of its physical integrity, surface characteristics, or dimensions. Furthermore, the processes should be economically practical on an industrial scale, e.g., providing for relatively fast removal of the core material to allow for further processing of the part.

### BRIEF DESCRIPTION OF THE INVENTION

The present invention provides a method of removing an yttria-based core from a niobium-based part, comprising the step of contacting the core with an effective amount of a leaching composition which comprises nitric acid, or a combination of nitric acid and phosphoric acid. The yttria-based core material can be effectively removed from the niobium-based part, and the process of removing the core does not detrimentally affect the quality of the part. (In this disclosure, the “leaching composition” is sometimes referred to as the “acid” or “acid composition”; and the term “acid” implies one or more acids).

Another aspect of the present invention is directed to a method of casting a part, comprising the steps of:

(a) positioning an yttria-based core within a mold;

(b) introducing a molten niobium-based alloy into the mold to cast a part; and

(c) dissolving the yttria-based core after casting the part, by contacting the core with an effective amount of a leaching composition which comprises nitric acid, or a combination of nitric acid and phosphoric acid.

Various other features, objects and advantages of the present invention will be made apparent from the following detailed description and the drawings.

### BRIEF DESCRIPTION OF THE DRAWINGS

The drawings illustrate one preferred embodiment presently contemplated for carrying out the invention:

FIG. 1 is a perspective view of a turbine in partial cross-section having a plurality of cast parts according to the present invention.

FIG. 2 is a perspective view of a cast blade usable with a turbine such as that shown in FIG. 1.

FIG. 3 is an elevational view of a cross-section of a mold for forming a cast part such as that shown in FIG. 2.

FIG. 4 is a partial cross-sectional view of the cast part along line 4-4 shown in FIG. 2.

FIG. 5 is a graphical representation of weight loss characteristics as a function of time, for a niobium silicide coupon being treated with a leaching composition according to this invention.

### DETAILED DESCRIPTION OF THE INVENTION

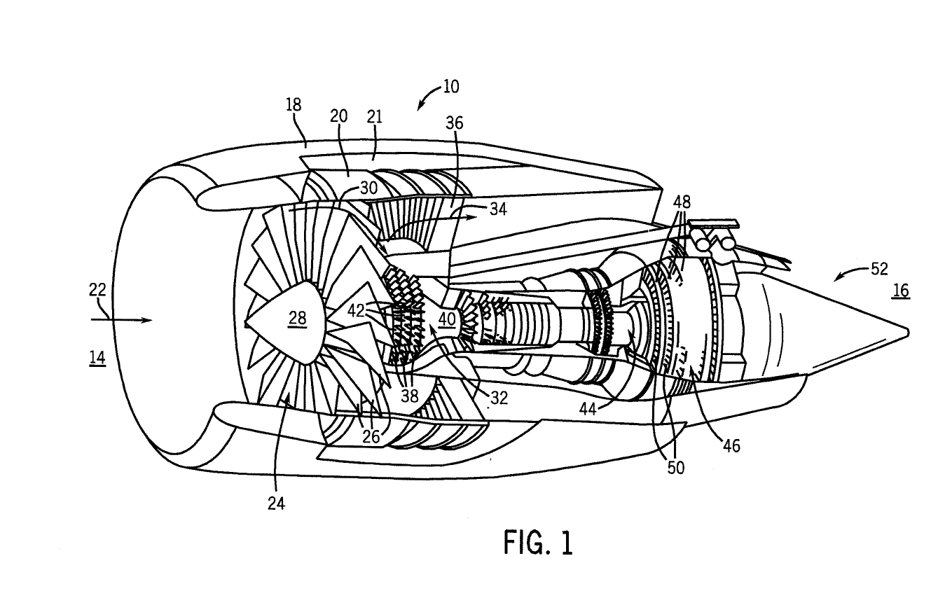

FIG. 1 shows an exemplary turbine engine, or turbine 10 having a plurality of parts cast according to the present invention. Turbine 10 includes an intake end 14 and a discharge end 16. A housing or shroud 18 is positioned about an exterior 20 of turbine 10, and includes a shroud cooling passage 21 formed therethrough. An air flow, indicated by arrow 22, enters turbine 10 through intake end 14 and passes through a first compressor stage or a fan 24. Fan 24 includes a plurality of blades 26 radially positioned about a hub 28. After air flow 22 has passed through fan 24, a first portion 30 of air flow 22 is directed to a compressor 32 and a second portion, or a bypass flow 34, of air flow 22 is directed through a perforated panel 36 and into shroud passage 21, thereby bypassing the remaining operational components of turbine 10.

Compressor 32 includes a plurality of fins or blades 38 attached to alternating stator hubs 40 and rotor hubs 42. During operation of turbine 10, blades 38 attached to each of rotor hubs 42, rotate past the blades 38 of adjacent stator hubs 40. The orientation of blades 38, the rotational speed of a particular hub as compared to adjacent hubs, and the shape of the blades are selected to generate a desired increase in the pressure and velocity of air flow 30. This specific hub configuration/orientation is merely exemplary and other hub configurations are envisioned and within the scope of the invention.

The highly pressurized, increased velocity air flow 30 exiting compressor 32 is then directed to a combustor 44. Combustor 44 introduces a preferably highly atomized fuel to air flow 30. Combustion of the air/fuel mixture even further increases the pressure and velocity of air flow 30. Air flow 30 is then directed to a turbine stage 46 of turbine engine 10. Turbine stage 46 includes a plurality of hubs 48, wherein each hub includes a plurality of vanes or blades 50. As air flow 30 passes between adjacent blades 50 of each hub 48, a portion of the pressure and velocity of air flow 30 is utilized to rotate the respective hub 48. For the aircraft engine shown, one or several of hubs 48 are connected through concentric shafts to drive fan 24 and rotor hubs 42 of compressor 32. Air flow 30 exiting turbine stage 46 of turbine 10 accentuates the thrust of air flow 34 generated by fan 24, and is discharged from turbine 10 through a nozzle 52, positioned about discharge end 16.

As one skilled in the art will appreciate, the components of turbines vary greatly depending on the intended application of the turbine. That is, an aircraft turbine engine may have a different configuration of components and parts than hydroelectric, geothermal, or other application-specific turbine engines/generators. Specifically, the construction of the turbine is commonly tailored to the fluid passed therethrough; the operational environment of the turbine; and the intended use of the turbine. For example, a turbine intended to generate electrical power may include a turbine stage having a first set of hubs utilized to rotate the rotors of the compressor, and another set of hubs utilized to drive a utility generator.

Regardless of the intended application of the turbine, each of the blades of the turbine must be constructed to withstand the motion, pressure, and temperature associated with turbine operation. As used herein, a turbine “part” or “component” includes any component of the turbine, including but not limited to, buckets, nozzles, blades, rotors, vanes, stators, shrouds, combustors, and blisks.

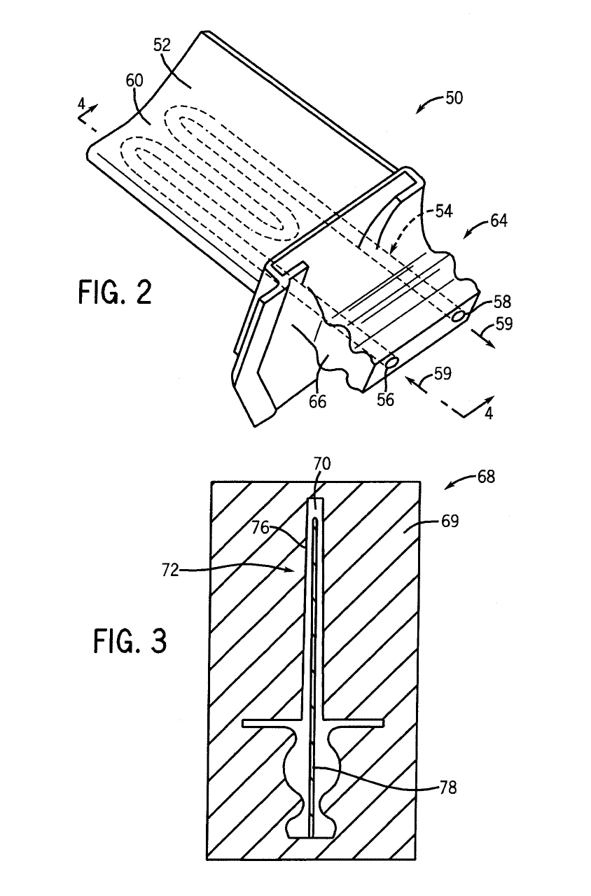

FIG. 2 shows exemplary blade 50 removed from turbine 10. Blade 50 includes a body 52 that is cast from a niobium-based material. Preferably, blade 50 is cast from a niobium-silicide based composite. The niobium-based composites exhibit desirable qualities with respect to low temperature toughness, high-temperature strength, and creep resistance for turbine blade construction. Furthermore, the niobium-based material construction of blade 50 allows the blade to operate at higher temperatures than a blade constructed from an iron, nickel, or other material-based “superalloy”. Although the niobium-based construction of blade 50 allows the blade to operate at temperatures that are higher than blades constructed of other materials, even greater operating temperatures can be achieved with integral cooling of the blade.

Body 52 of blade 50 includes a passage 54 that is integrally cast therethrough. Passage 54 includes an inlet 56 and an outlet 58, such that a flow, indicated by arrows 59, can be passed through body 52 of blade 50. Understandably, the orientation of passage 54, as well as the relative positions of inlet 56 and outlet 58, are merely exemplary, and in no way limit the scope of the invention. As discussed further with respect to FIG. 3, passage 54 is formed during the casting of blade 50, by traversing the cavity of a mold with a core, and casting blade 50 within the mold and about the core.

Passage 54 allows flow 59 to pass into and through body 52 of blade 50 of turbine 10. Flow 59 removes heat associated with operation of turbine 10 from blade 50, and thereby allows blade 50 to withstand higher operating temperatures than a blade having a similar shape, and formed of a similar material without passages therethrough. The increased turbine operating temperatures achievable with blade 50 increases the operating efficiency of an engine equipped with the blades. That is, the efficiency of turbine 10 is directly related to the operating temperature thereof. Thereby, blade 50 provides for increased turbine operating temperatures, thereby increasing the operating efficiency of turbine 10.

Blade 50 includes a shank 64 extending therefrom. Shank 64 is constructed to allow blade 50 to be quickly and securely attached to hub 48, shown in FIG. 1. As shown in FIG. 2, shank 64 has a geometric cross-section 66, which allows shank 64 to slidingly engage the hub of turbine 10, such that blade 50 is securely attached thereto to withstand the rotational forces associated with operation of turbine 10. Blade 50 is formed by pouring a molten material having properties of low temperature toughness, high-temperature strength, and creep resistance, that are generally similar or the same as the material properties of a niobium-based alloy into a mold.

As shown in FIG. 3, a mold 68 includes a body having a cavity 70 formed therein. Cavity 70 has a shape 72 which substantially matches, or is a near net equivalent of, the shape of blade 50. A core 78 extends into cavity 70 and is encased by the niobium-based material of the part during the casting process. Core 78 is usually formed of an yttria-based material. As used herein, “yttria-based” refers to a material which contains at least about 50% by weight yttria, and in some instances, at least about 75% by weight yttria. Such materials can often comprise substantially all yttria. Alternatively, they can also include oxides of any of aluminum, magnesium, calcium, strontium, niobium, silicon, hafnium, titanium, zirconium, rare earth metals of the lanthanide series, and/or any combination thereof, including any reaction products or phases which could form from any of these constituents, such as yttrium aluminate, and the like. Yttria-based materials are an important component for niobium silicide castings, because of their chemical stability and inertness. (In marked contrast, silica-based core materials typically used for casting nickel superalloys can be very reactive with niobium silicide parts, and are therefore very undesirable in this application).

With continued reference to FIG. 3, core material 78 is selected to withstand the temperatures associated with the casting process, and to be formable to a desired core shape. Core material 78 is further selected to be removable from the cast part with minimal or negligible interference with the cast part, by the means applied to remove the cores. That is, the yttria-based material is removed from the part, as discussed further below, by subjecting the cores to an effective amount of a selected acid or acid system.

As alluded to previously, several important considerations must be addressed in removing the yttria-based core material from the niobium-based part, including the rate of reaction of the selected acid with the yttria-based core; the concentration of the acid selected; the temperature and pressure at which the process is carried out; and the potential reactivity between the acid and the part. That is, an acid cannot be selected simply because it sufficiently dissolves an yttria-based core. It must also not detrimentally affect the part being produced.

For the present invention, the leaching composition comprises nitric acid, or a combination of nitric acid and phosphoric acid. The inventors have discovered that these acid systems are particularly effective at removing yttria-based core materials from niobium-based components formed in a casting process. Moreover, these acids, or combinations thereof, do not appreciably degrade the niobium-based alloy itself—a critical consideration when casting high performance turbine components. As further discussed below, a “passivation effect” appears to provide the foundation for the unexpected effectiveness of these acid systems on niobium-based parts.

In some specific embodiments, the leaching composition comprises at least about 50% by weight nitric acid, i.e., based on total acid content. In preferred embodiments for certain end use applications, the leaching composition is predominantly nitric acid, e.g., at least about 75% by weight. However, combinations of nitric acid and phosphoric acid can also be effective in some instances, as set forth in the Examples section. In those instances, the weight-ratio of nitric acid to phosphoric acid will usually range from about 99:1 to about 65:35.

In some instances, the concentration of the acid (as designated from a commercial source, or as adjusted by the user) is taken into account in carrying out the process of this invention. For example, nitric acid is commercially available at up to 91% concentration, and performs acceptably between about 5% and 91% concentration. (As used hereinafter, reference to the concentration of an acid refers to the weight percent concentration of the acid). Preferably (though not always), when nitric acid is utilized to remove the core material, it is maintained between about 20% and about 70% concentration. Furthermore, nitric acid has an azeotropic attribute wherein the acid solution of nitric acid and water will gravitate to a concentration of 68% when maintained at about 120.5° C. The azeotropic nature of the nitric acid solution allows the concentration of the solution to remain relatively constant during boiling (and thereby evaporation) of the solution. Understandably, the acid (or acid mixture) selected will have a desired concentration that is not necessarily the same as other applicable acids.

Understandably, these ranges are merely exemplary, and manipulating other variables of the system could result in beneficial results with acids having concentration beyond those expressly stated. Furthermore, it is appreciated that the concentration of the acid or acid mixtures, such as nitric/phosphoric mixtures, be tailored to a range wherein the mixture adequately dissolves the core material, without detrimentally affecting the material of the part. Understandably, concentration, pressure, and temperatures associated with the core removal process can be adjusted, based on the teachings herein.

Referring to FIG. 3, as the molten niobium-based cast material is introduced into cavity 70 during the casting process, the cast material generally encompasses core 78. When mold body 69 is removed from the cast part, core 78 remains in the cast part, due to the generally internal position of core 78 relative to an outer surface of the cast part, indicated by an interface 76 of cavity 70 and mold 69. When core 78 is removed from the cast part, passage 54, as shown in FIG. 2, is formed through the cast part. Although core 78 is configured to form a passage through the cast part, other core shapes and orientations are envisioned and within the scope of the invention, such as providing a core member completely internal to the cast part, or having a single opening thereto.

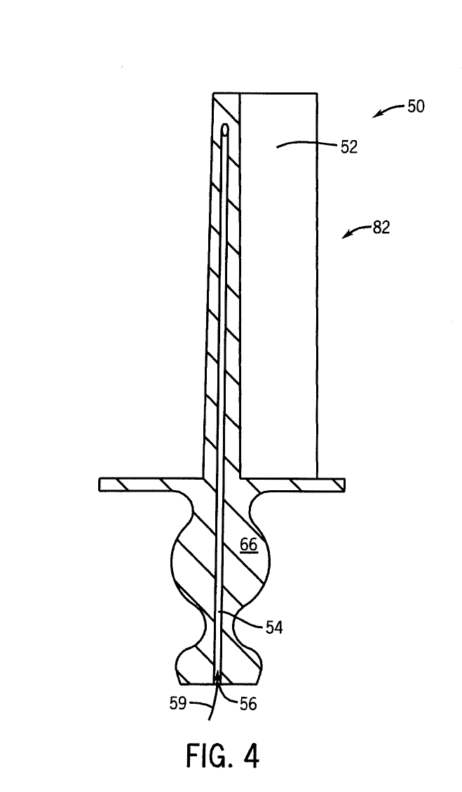

As shown in FIG. 4, cast blade 50 has been removed from a mold similar to mold 68, shown in FIG. 3. A shape 82 of blade 50, although shown in cross-section, substantially matches shape 72 of cavity 70 of mold 68 (FIG. 3). Core 78, as shown in FIG. 3, has been removed from blade 50 (FIG. 2), thereby clearing passage 54, formed through blade 50. Passage 54 provides a cooling path through body 52 of blade 50. Flow 59 is directed into inlet 56 and through passage 54, and passes through blade 50 in a generally serpentine manner, thereby cooling blade 50 and removing operational heat therefrom. Understandably, surface passages could also be formed through the blade 50, and fluidly connected to passage 54, to allow surface cooling of blade 50 during operation thereof.

Core 78, regardless of its shape, is removed from blade 50 by exposing core 78 of blade 50 to a leaching composition, i.e., an acid or acid-based composition as specified herein. As alluded to above, the composition is selected, such that there is minimal or negligible reaction between the acid and the niobium-based material of the part, while the acid is still capable of readily dissolving the yttria-based material of the cores. Thus, the core removal material/solution is substantially non-reactive with the niobium-silicide based materials of blade 50, while being very reactive with the yttria-based material of the cores. Such an association ensures that the removal of core 78 from blade 50 maintains a desired quality of the cast part; and enhances manufacturing efficiency.

It should also be understood that the conditions associated with this process are tailored to produce a desired part. That is, the temperature of the leaching composition is usually (though not always) maintained between about 40 degrees Celsius and about 120 degrees Celsius. Preferably, the upper temperature limit is generally defined by the boiling point of the acid selected. Those skilled in the art will appreciate that a boiling point is sometimes expressed as a constant boiling point; and that some acids, such as nitric acid, have an azeotrope with water. An azeotrope will boil without changing composition. Since each acid and/or acid combination has a specific boiling point, the upper temperature limit can be selected for the specific acid and/or acid combination utilized.

Understandably, manipulating the operating pressure of the process affects the boiling temperature of the leaching composition, i.e., the acid, such that higher operating temperatures can be achieved through the use of an autoclave, or similar types of equipment. With the use of an autoclave, temperatures higher than 120 degrees Celsius can be achieved, and are within the scope of the invention. In some instances, agitation is used to enhance the interaction of the acid with the core material. Such agitation could include physically manipulating the part and/or the acid, or providing a stirring function. Sonic stirring could also be employed. Various adjustments in temperature and pressure may also be helpful in ensuring maximum contact between the treatment solution and the core. Furthermore, it is appreciated that dissolved and/or loosened core material or residue can be removed with techniques such as rinsing, blowing with gas, and the like.

The treatment time can vary as well. As a non-limiting example, treatment times in the range of about 1 hour to about 100 hours have been found to efficiently dissolve yttria-based core materials, using a nitric acid-based treatment solution, and without substantially affecting the niobium-based material of the part. Understandably, the temperature, pressure, and concentration of the acid, as well as the duration of exposure of the core and/or cast part to the acid, affect both the rate of removal of the cores, and the effect of the acid on the cast part. Other factors to be considered are the size of the part being treated, as well as the size, location, and depth of cavities in which the core material may be present. Moreover, those skilled in the art understand the interdependence of some of the variables, e.g., with higher temperatures sometimes compensating for shorter treatment times.

Moreover, the selection of a specific acid to remove the yttria-based core requires consideration of several parameters, including the specific composition of niobium-based part material; the level of acceptable interaction between the niobium-based material and the acid; the temperature and duration of exposure of the part to the acid; the availability and cost of the acid and/or its constituents; the specific composition of the yttria-based core material; and the density of the core material. Understandably, these are but a few of the many considerations which must be addressed to realize a feasible core material process.

### EXAMPLES

The following examples serve to illustrate the features and advantages offered by the present invention, and are not intended to limit the invention thereto.

### Example 1

As a first example, an yttria-based bar and a NbSi alloy of similar size, and having compositions and densities, respectively, for use as materials in a turbine engine, were placed in an autoclave. The autoclave contained a 20 wt % NaOH solution. The autoclave was heated to 290 degrees Celsius, and held at that temperature for 2.5 hours. After exposure to these conditions, the yttria-based bar was still largely intact, but swelled to a larger dimension. The NbSi alloy was mostly dissolved, and the remaining reaction products from the alloy were present at the bottom of the container, as multiple flakes. Such a process evidenced that the NbSi alloy dissolved faster than the yttria bar, thereby showing that a caustic solution of NaOH would not be effective for removing an yttria-based core from a niobium-based part.

### Example 2

In another example, similarly sized yttria-based bars and pieces of a NbSi alloy, both of composition and density desirable for use as materials in a turbine engine, were placed in nitric acid solutions, at concentrations of 20 wt % and 69 wt %, as shown in the following table. The yttria bar was substantially dissolved after 2 hours at 95 degrees Celsius, while very limited attack of the NbSi alloy occurred after 24 hours at 95 degrees Celsius. The relative rate of dissolution was high for the yttria, and low for the alloy. Therefore, it is readily apparent that nitric acid is very useful for removing the yttria, without significantly attacking the alloy. Understandably, other parameters of concentration, temperature, and pressure are envisioned and within the scope of the invention.

| | | Weight Loss of | | |
|---|---|---|---|---|
| | Weight Loss of 69% | NbSi Alloy after | Relative | Relative Dissolution |
| Acid/ | Density Yttria after 2 | 24 hrs at 95° C. | Dissolution | Rate of NbSi |
| Concentration | hrs at 95° C. (%) | (%) | Rate of Yttria | Containing Alloy |
| Nitric Acid 20% | 73% | 0.02% | High | Low |
| Nitric Acid 69% | 78% | 0.01% | High | Low |

### Example 3

In another example, similarly sized yttria-based bars and pieces of NbSi alloy, both of composition and density desirable for use as materials in a turbine engine, were placed in a nitric acid solution at concentrations of 69 wt %, as shown in the following table. The yttria bar was substantially dissolved after 1 hour at 115 degrees Celsius, while very limited attack of the NbSi alloy occurred after 24 hours at 115 degrees Celsius. Compared to the previous example at 95 degrees Celsius, the dissolution rate of the yttria-based material substantially increased, while the dissolution rate of the alloy was relatively unchanged. The relative rate of dissolution was high for the yttria-based material, and low for the alloy, thereby showing that nitric acid is useful for removing the yttria-based material without significantly attacking the alloy. Understandably, other parameters of concentration, temperature, and pressure are envisioned and within the scope of the invention.

| | | Weight Loss of | | |
|---|---|---|---|---|
| | Weight Loss of 69% | NbSi Alloy after | Relative | Relative Dissolution |
| Acid/ | Density Yttria after 1 | 24 hrs at 115° C. | Dissolution | Rate of NbSi |
| Concentration | hr at 115° C. (%) | (%) | Rate of Yttria | Containing Alloy |
| Nitric Acid 69% | 86% | 0.02% | High | Low |

While it is known in the art that niobium itself is resistant to nitric acid, the incorporation of various phases (e.g., one or more silicide phases) and alloying elements into niobium could have resulted in alloys which could be partially or fully attacked with nitric acid. Thus, the effectiveness of nitric acid in this process was somewhat unexpected.

### Example 4

In yet another example, yttria-based core material bars and NbSi alloy part material pieces of similar size, both of composition and density generally used in forming turbine engines, were placed in a mixture of 1:1 phosphoric/nitric acid of concentrations of 20 wt % and 70 wt %, as shown in the following table. The yttria-based core material bar was substantially dissolved after 2 hours at 95 degrees Celsius, while very limited attack of the NbSi part material occurred after 24 hours at 95 degrees Celsius. The relative rate of dissolution was higher for the yttria-based material and lower for the alloy, when the 1:1 phosphoric/nitric acid content was 70 wt %. At the lower acid concentration of 20 wt %, the dissolution rate of the yttria-based material decreased. However, despite the lower dissolution rate, the removal rate of the yttria-based material was still orders of magnitude greater than the dissolution rate of the alloy of the part material.

In some embodiments, the 1:1 phosphoric/nitric acid mixture at 70 wt % proved particularly useful for removing the yttria-based core material, without significantly attacking the alloy of the part material. The lower concentration of 20 wt % can also be effectively used to remove yttria-based material, without significant attack of the part material, when the time period for removal of the core material from the part is not a large issue. Understandably, the acid concentrations of 20 wt % and 70 wt %, and the 1:1 ratio of the phosphoric to nitric acid of the mixture, are merely for purposes of illustration, and do not limit the invention.

| | | Weight Loss of | | |
|---|---|---|---|---|
| | Weight Loss of 69% | NbSi Alloy after | Relative | Relative Dissolution |
| Acid/ | Density Yttria after 2 | 24 hrs at 95° C. | Dissolution | Rate of NbSi |
| Concentration | hrs at 95° C. (%) | (%) | Rate of Yttria | Containing Alloy |
| Nitric/Phosphoric 20% | 19% | 0.10% | Medium | Low |
| Nitric/Phosphoric 70% | 45% | 0.14% | High | Low |

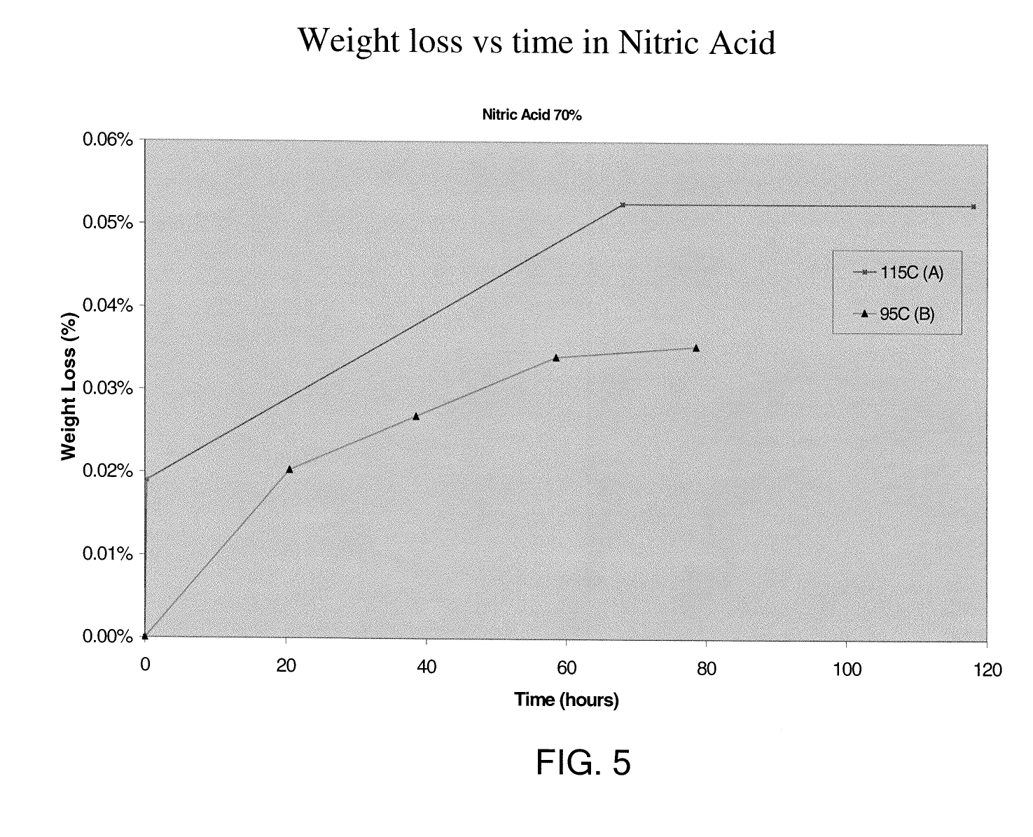

(It should also be noted that the parent application for the present case, application Ser. No. 11/276,002, provides comparative, graphical representations for yttria-based core materials and niobium-based parts, using a variety of different types of acids, e.g., see FIGS. 5 and 6 of the parent case, and the associated explanations for those figures).

### Example 5

In yet another example, a nickel-based superalloy sample (as compared to a niobium-based material) useful in the manufacture of jet engine turbine blades was placed in 68 wt % nitric acid at 95 degrees Celsius for 99 hours. The sample was removed from the acid. A polished section cut from the sample was prepared, and the surface roughness of the section was examined in a scanning electron microscope, and compared to an untreated sample of alloy. The acid-treated nickel superalloy surface was severely pitted, and would be unacceptable for conventional jet engine construction.

FIG. 5 is a graphical representation of weight loss characteristics as a function of time, for a niobium-silicide coupon (button) being treated with a leaching composition according to this invention. The sample was formed of a niobium-silicide alloy. The leaching composition was 70% by weight nitric acid in water, and treatment was carried out by immersion of the button in a bath of the leaching composition. As indicated in the figure, two different niobium-silicide samples were used. Sample A was treated in a bath at a temperature of 115° C., while Sample B was treated at 95° C.

FIG. 5 illustrates the “passivation effect” mentioned above. Some initial attack of the sample occurs, but the amount of material removed is too small to be detrimental to the alloy sample. The minor, initial attack is followed by passivation of the surface, i.e., little or no additional attack, as shown by the leveling-off of substrate weight loss as the treatment time continues. Although the inventors do not wish to be bound by any specific theory, it is believed that passivation of the niobium-silicide alloy during the nitric acid treatment may be occurring because of the diffusion of oxygen into the metal surface, forming an oxide layer on the surface. (It has also been observed that contact with the leaching composition appeared to considerably smoothen the surface profile).

The discovery of the passivation effect in a leaching process for the niobium-silicide components was somewhat surprising. For example, turbine engine components formed for many years with nickel-based superalloys would be readily attacked when contacted with nitric acid. In that instance, it appears that oxides forming on the substrate surface are continuously dissolved by the nitric acid, thereby preventing the formation of a relatively stable protective oxide. The nitric acid or nitric/phosphoric acid treatments for the state-of-the-art niobium-silicides represent a critical alternative to the conventional leaching materials (e.g., the caustic compounds), which had been employed for typical nickel alloys. The caustic compounds would damage the NbSi alloys, as noted previously.

As one of ordinary skill in the art will appreciate, the examples set forth above are merely exemplary, and in no way limit the scope of the invention. Understandably, other acid concentrations other than those explicitly provided are envisioned. Furthermore, it is appreciated that the composition of the acid (i.e., the leaching composition) is determined, in part, by the composition of the part material; the composition of the core material; the temperature and pressure associated with removing the core materials; the availability of the acid; and the cost associated therewith. Those skilled in the art understand that variable parts and processes may sometimes affect the relative importance of any one of these parameters. As an example, longer contact times may compensate for lower acid concentrations and/or lower treatment temperatures. Accordingly, the examples provided herein are in no way intended to limit the scope of the claimed invention.

The patentable scope of the invention is defined by the claims. While this invention has been described in detail, with reference to specific embodiments, it will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent publications, articles, texts, and other references mentioned above are incorporated herein by reference.

What is claimed is:

1. A method of removing an yttria-based core from a niobium-based part, comprising the step of:
contacting the yttria-based core with an effective amount of a leaching composition which comprises nitric acid, or a combination of nitric acid and phosphoric acid.

2. The method of claim 1, wherein the leaching composition is heated during contact with the yttria-based core, to a temperature of at least about 40° C.

3. The method of claim 2, wherein the heating temperature is approximately the boiling temperature of the leaching composition at a selected pressure.

4. The method of claim 1, wherein the yttria-based core is contacted with the leaching composition within a bath of the composition.

5. The method of claim 4, wherein the bath is agitated during contact with the yttria-based core.

6. The method of claim 1, wherein the leaching composition comprises at least about 50% by weight nitric acid, based on total acid content.

7. The method of claim 6, wherein the leaching composition comprises at least about 75% by weight nitric acid.

8. The method of claim 1, wherein the niobium-based part comprises a niobium silicide material.

9. The method of claim 8, wherein the niobium silicide material comprises at least about 1 atom % to about 25 atom % silicon, and further comprises at least one element selected from the group consisting of titanium, hafnium, chromium, and aluminum.

10. The method of claim 1, wherein the yttria-based core comprises yttria and at least one other metal oxide.

11. The method of claim 10, wherein the metal oxide comprises at least one metal selected from the group consisting of aluminum, magnesium, calcium, strontium, niobium, silicon, hafnium, zirconium, titanium, and a rare earth metal.

12 The method of claim 1, wherein contact with the leaching composition is sufficient to remove substantially all of the yttria-based core, while leaving the niobium-based part substantially unaffected.

13. A method of casting a part, comprising the steps of:
(a) positioning an yttria-based core within a mold;
(b) introducing a molten niobium-based alloy into the mold to cast a part; and
(c) after casting the part, dissolving the yttria-based core by contacting the core with an effective amount of a leaching composition which comprises nitric acid, or a combination of nitric acid and phosphoric acid.

14. The method of claim 13, wherein the yttria-based core comprises yttria and at least one other metal oxide comprising a metal selected from the group consisting of aluminum, magnesium, calcium, strontium, niobium, silicon, hafnium, zirconium, titanium, and a rare earth metal.

15. The method of claim 13, wherein the leaching composition is heated during contact with the yttria-based core, to a temperature of at least about 40° C.

16. The method of claim 13, wherein the yttria-based core is contacted with the leaching composition within a bath of the composition.

17. The method of claim 13, wherein the niobium-based alloy comprises a niobium-silicide material.

18. The method of claim 13, wherein the part is a turbine engine component.

19. The method of claim 18, wherein the component is a turbine engine blade which includes at least one internal cavity formed with the yttria-based core; and substantially all of the core material is removed from the internal cavity by contact with the nitric acid-based or nitric/phosphoric acid-based leaching composition.
